(19) United States
(12) Patent Application Publication
(10) Pub. No.: US 2013/0043674 A1
(43) Pub. Date: Feb. 21, 2013

(54) PIPE CONNECTION OR HOSE CONNECTION

(71) Applicant: Ralf Ziegler, Benningen (DE)

(72) Inventor: Ralf Ziegler, Benningen (DE)

(73) Assignee: Audi AG, Ingolstadt (DE)

(21) Appl. No.: 13/372,115

(22) Filed: Feb. 13, 2012

(30) Foreign Application Priority Data
Feb. 14, 2011 (DE) 10 2011 011 168.9

(51) Int. Cl. F16L 33/20

(52) U.S. Cl. 285/242

(57) ABSTRACT

A pipe/hose connection includes a pipe/hose end attached exterior to a pipe socket, and a clamp securing the pipe/hose end on the pipe socket. The pipe/hose end has a radially inwardly protruding, circumferential first ring collar, and the pipe socket has an outwardly protruding circumferential second ring collar. The second circumferential ring collar extends along a first plane that is perpendicular to a longitudinal center axis of the pipe socket, whereas the first circumferential ring collar intersects at least at two locations with a second plane that is perpendicular to a longitudinal center axis of the pipe/hose end. The two ring collars are then not simultaneously in contact along their entire length when the first ring collar moves across the second ring collar when the pipe/hose end is attached on the pipe socket. The pipe/hose end can be secured on the pipe socket with a clamp.

### CROSS-REFERENCES TO RELATED APPLICATIONS

This application claims the priority of German Patent Application, 10 2011 011 168.9, filed on Feb. 14, 2011, pursuant to 35 U.S.C. 119(a)-(d), the content of which is incorporated herein by reference in its entirety as if fully set forth herein.

### BACKGROUND OF THE INVENTION

The present invention relates to a pipe connection or hose connection with a pipe socket, a pipe end or hose end attached on the outside on the pipe socket, and a clamp holding the pipe end or hose end on the pipe socket. The present invention also relates to an air pipe or an air hose using this pipe connection or hose connection, in particular for an intake passage of a combustion engine, as well as to a component with such pipe socket.

The following discussion of related art is provided to assist the reader in understanding the advantages of the invention, and is not to be construed as an admission that this related art is prior art to this invention.

With intake air pipes or air hoses as well as charge-air pipes or charge-air hoses, which are produced by blow molding and have a pipe end or hose end for attachment on a pipe socket of an air filter, a charge-air cooler and the like, the pipe end or hose end is frequently secured on the pipe socket with a clamp. To position the clamp at the designated position on the pipe end or hose end, the pipe end or hose end may have on its outer circumference a clamp seat which prevents axial movement of the clamp along the pipe end or hose end during or after the clamp is tightened. A ring collar protruding radially inwardly from the clamp seat on the inner circumference of the pipe end or hose end is frequently formed at the location where the clamp seat is arranged on the outer circumference of the pipe end or hose end. When the clamp is tightened, this ring collar causes a local increase in the surface contact pressure between the pipe end or hose end and the pipe socket radially inwardly from the clamp, thereby improving the sealing effect. The ring collar extends typically along a center plane of the clamp or the clamp seat and is somewhat narrower than the clamp or the clamp seat, because only then can the surface contact pressure be locally increased. The inner diameter of the ring collar corresponds substantially to the outer diameter of the outer circumference of the pipe socket, so that the ring collar slides along the outer circumference when the pipe end or hose end is attached on the pipe socket.

However, a large number of pipe sockets have at their outer circumference at least one protruding ring collar to improve the seating of a hose made from a flexible or yieldable material and attached on the pipe socket through local expansion of the peripheral wall of the hose radially outwardly from the ring collar, and to optionally prevent—with the expansion of the peripheral wall—a clamp placed after the expansion for securing the hose end from moving in the axial direction. Such ring collar can protrude over the outer periphery of the pipe socket by several millimeters. To facilitate installation of a pipe end or hose end on a pipe socket, such ring collar is sometimes also provided on the free end of the pipe socket, which locks or snaps in an expansion of the cross-section of the pipe end or hose end, as soon as the pipe end or hose end has been pushed far enough onto the pipe socket.

The ring collar may cause problems, in particular when a pipe end or hose end of an intake air pipe or charge-air pipe, or an intake air hose or a charge-air hose of the aforedescribed type and produced by blow molding is to be attached on the pipe socket. Because such pipe end or hose end, unlike a pipe end or hose end made from an elastomer material, cannot be expanded due to the small elasticity of the plastic material, the ring collar which protrudes inwardly over the inner circumference of the pipe end or hose end cannot be moved over the outwardly protruding ring collar on the pipe socket at all or only by applying substantial force which puts the pipe end or hose end, risking tearing. One underlying cause for these problems is that both the ring collar on the inner circumference of the pipe end or hose end as well as the ring collar on the outer circumference of the pipe socket extend along a plane oriented perpendicular to the longitudinal center axis of the pipe end or hose end and of the pipe socket, respectively, so that they contact each other simultaneously along their entire circumferential length when the pipe end or hose end is attached on the pipe socket.

To solve the problem, either the pipe socket or the pipe end or hose end must be modified or an intermediate piece made from an elastomer material must be inserted between the pipe end or hose end and the pipe socket. Both solutions of this problem are complex and expensive, wherein the first-mentioned solution is difficult to implement when the component with the pipe socket and the intake pipe or charge-air pipe or the intake hose or charge-air hose are used in other combustion engines from the same company in different installation situations.

It would therefore be desirable and advantageous to obviate prior art shortcomings and to provide an improved a pipe connection or hose connection of the aforementioned type, an air pipe or an air hose of the aforementioned type, as well as a component of the aforementioned type so that the pipe end or hose end can be more easily attached to the pipe socket.

### SUMMARY OF THE INVENTION

According to one aspect of the present invention, a pipe connection or hose connection includes a pipe socket having at least one outwardly protruding circumferential second ring collar, a pipe end or hose end having a radially inwardly protruding, circumferential first ring collar, wherein the pipe end or hose end are attached on an outside of the pipe socket, and a clamp securing the pipe end or hose end on the pipe socket. The first ring collar has a width that is smaller than a width of the clamp, and the first ring collar moves over the second ring collar when the pipe end or hose end is placed onto the pipe socket. The second circumferential ring collar extends along a first plane that is perpendicular to a longitudinal center axis of the pipe socket, while the first circumferential ring collar intersects at least at two locations with a second plane that is perpendicular to the longitudinal center axis of the pipe end or hose end. The two ring collars are then no longer simultaneously in contact along their entire length when the first ring collar moves across the second ring collar when the pipe end or hose end is placed onto the pipe socket.

According to an advantageous feature of the present invention, the second plane may be a longitudinal center plane of the clamp or of a clamp seat, and the first ring collar extends partially on both sides of this plane. The two ring collars then no longer contact each other simultaneously along the entire length, when the pipe end or the hose end is attached on the pipe socket. Instead, the two ring collars move sequentially across one another. At any time, they make contact only at few contact points, whereas between the contact points a narrow gap exists between the ring collar on the inner circumference of the pipe end or hose end and the opposing outer circumference of the pipe socket, or between the ring collar on the outer circumference of the pipe socket and the opposing inner circumference of the pipe end or hose end. Because of this gap, the pipe socket and/or the pipe end or hose end can be slightly deformed between the contact points, so that the two ring collars more easily slides across each other at the contact points.

The pipe socket and/or the pipe end or hose end are then the more distorted, the smaller their wall thickness and the larger their diameter is. Because the intake air pipes or hoses and the charge-air pipes or hoses, respectively, produced by blow molding have a relatively small wall thickness in relation to their diameter, the deformation of the pipe end or hose end is typically adequate for moving the first circumferential ring collar across the second circumferential ring collar when the pipe end or hose end is attached on the pipe socket.

In the context of the present patent application, circumferential ring collar refers to a continuous collar extending without interruption in the shape of a ring along the entire circumference of the pipe end or hose end and of the pipe socket, respectively.

According to an advantageous feature of the present invention, the second circumferential ring collar protruding outwardly over the outer circumference of the pipe socket extends along a plane that is perpendicular to the longitudinal center axis of the pipe socket, whereas the first circumferential ring collar protruding inwardly over the inner circumference of the pipe end or hose end intersects at least at two locations a plane that is perpendicular to the longitudinal center axis of the pipe end or hose end, preferably the center plane of the clamp or a clamp seat. When the pipe socket is used in several applications, on one hand, for attaching blow-molded pipes or hoses and, on the other hand, for attaching elastically deformable hoses, seating of an elastically deformable hose end placed on the pipe socket can advantageously be improved in the latter case by a ring collar extending perpendicular to the longitudinal center axis of the pipe socket.

According to an advantageous feature of the present invention, the same result can generally be achieved, when the first circumferential ring collar protruding inwardly over the inner circumference of the pipe end or hose end extends along a plane which is perpendicular to the longitudinal center axis of the pipe end or hose end, preferably along the center plane of the clamp or of a clamp seat, whereas the second circumferential ring collar protruding outwardly over the outer circumference of the pipe socket intersects at least at two locations a plane that is perpendicular to the longitudinal center axis of the pipe socket.

According to an advantageous alternative feature of the present invention, the first circumferential ring collar may extend along a plane that is inclined with respect to the longitudinal center axis of the pipe end or hose end, wherein the first ring collar may then intersect at least at two locations with the center plane of the clamp or of the clamp seat, which is perpendicular to the longitudinal center axis of the pipe end or hose end, with respective halves the first circumferential ring collar extending on both sides of the center plane. In this alternative embodiment, when the pipe end or hose end is attached on the pipe socket, the first circumferential ring shoulder first makes contact with the outwardly protruding ring collar of the pipe socket only at a single contact point, thus facilitating an increase of the inner radius at this contact point through deformation of the pipe end or hose end. When the two ring collars have moved across each other at this contact point, they make contact during the further relative movement of the pipe end or hose end and of the pipe socket at two contact points moving in opposite directions about the circumference of the pipe end or hose end and of the pipe socket, respectively, whereby they first move away from each other and then move again towards each other.

According to an advantageous feature of the present invention, the first circumferential ring collar may have a wavy shape, with two wave crests and two wave troughs advantageously disposed in the circumferential direction of the pipe end or hose end, so that the first circumferential ring collar simultaneously contacts the second circumferential ring shoulder at two contact points when the pipe end or hose end is attached on the pipe socket. While the two circumferential ring collars move across each other, they are hereby in mutual contact at four contact points, thus leaving enough space between the adjacent contact points to allow adequate deformation of the pipe end or hose end. Advantageously, the ring collar may protrude an equal distance to both sides over the center plane of the clamp seat or of the clamp that is perpendicular to the longitudinal center axis of the pipe end or hose end, so that the pressure applied by the clamp after the clamp is tightened is introduced uniformly across the pipe end or hose end into the pipe socket along the entire length of the first the circumferential ring shoulder.

According to an advantageous feature of the present invention, the pipe end or hose end may form a part of an intake or charge-air pipe or hose produced from plastic by blow molding, wherein the circumferential first ring collar is a ring collar that is formed during blow molding as a single piece on the inner circumference of the pipe end or hose end. The pipe socket may be a pipe socket formed from plastic by injection molding or from metal by casting and/or machining and may, for example, protrude over a filter housing of an air filter made of plastic and/or a metal housing of a charge-air cooler.

According to another aspect of the invention, an air pipe or air hose includes a pipe end or hose end for attachment on a pipe socket, which has a clamp seat for a clamp used for securing the pipe end or hose end on the pipe socket and a circumferential ring collar which protrudes radially inwardly from the clamp seat and has a width which is smaller than the width of the clamp seat. The ring collar intersects at least at two locations with a plane that is perpendicular to the longitudinal center axis of the pipe end or hose end. The ring collar may advantageously extend either along a plane that is inclined with respect to the longitudinal center axis of the pipe end or hose end, or has a wavy shape.

According to an advantageous feature of the present invention, to facilitate attachment of the pipe end or hose end on the pipe socket, the pipe end or hose end may include a conically expanding free end, known in the technical field also as flaring, in the installation direction before the clamp seat.

According to another advantageous feature of the present invention, the cross-section of the pipe end or hose end may be narrowed in the installation direction after the clamp seat, wherein the pipe end or hose end may advantageously have the same inner diameter as the pipe socket, so as to keep the flow resistance inside the, pipe connection or hose connection as small as possible. The cross-section may be narrowed directly after the free end of the pipe socket, after the pipe socket has been inserted in the pipe end or hose end and the clamp has been secured on the clamp seat.

According to another advantageous feature of the present invention, when the second ring collar protruding over the outer circumference of the pipe socket is arranged on the free end of the pipe socket, the pipe end or hose end may include an additional expansion of the cross-section after the clamp seat and before the narrowing of the cross-section, in which the second ring collar can lock after passing over the first ring collar.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows a longitudinal cross-sectional view of a pipe socket and a pipe end or hose end of an intake or charge-air hose according to the present invention before attachment on the pipe socket;

FIGS. 2 and 3 show views according to FIG. 1, however at different stages during attachment of the pipe end or hose end on the pipe socket;

FIG. 4 shows a view according to FIGS. 1 to 3, however after attachment of the pipe end or hose end on the pipe socket;

FIG. 5 shows a longitudinal cross-sectional view of a slightly modified pipe end or hose end of an intake or charge-air hose according to the present invention.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

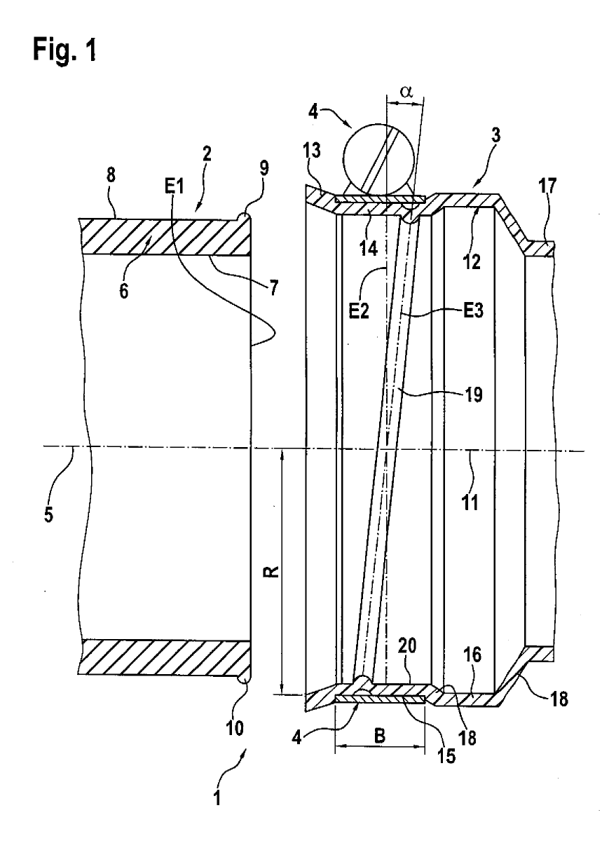

Turning now to the drawing, and in particular to FIG. 1, there is shown a pipe connection or hose connection 1 of an air intake passage of a motor vehicle with a pipe socket 2 protruding, for example, over a filter housing of an air filter (not illustrated) and being formed as one-piece on the filter housing when the plastic housing is manufactured. The pipe connection or hose connection 1 furthermore includes an expanded pipe end or hose end 3 of a plastic intake air pipe or intake air hose (not illustrated) produced by blow molding, which is attached on the outside of the pipe socket 2 and secured on the pipe socket 2 with a pipe or hose clamp 4, as illustrated in FIGS. 1 to 4. The pipe or hose clamp 4 may be any clamp suitable for this purpose and will therefore not be described here in greater detail.

As best seen from FIG. 1, the pipe socket 2 has a longitudinal center axis 5 and a circumferential wall 6 arranged coaxially with respect to the longitudinal center axis 5 and bounded by an inner cylindrical circumferential surface 7 and an outer cylindrical circumferential surface 8. A ring collar 9 is formed on the free end of the pipe socket 2; the ring collar 9 extends uninterruptedly around the entire circumference of the pipe socket 2 along a plane E1 that is perpendicular to the longitudinal center axis 5 and aligned with the end face of the pipe socket 2; the ring collar 9 protrudes outwardly over the outer circumferential surface 8 and is undercut in the axial direction towards the circumferential surface 8. The ring collar 9 has a convex rounded outer circumferential surface 10.

As also best seen from FIG. 1, the pipe end or hose end 3 has a longitudinal center axis 11 which after attachment on the pipe socket 2 is aligned with the longitudinal center axis 5 of the pipe socket 2. The pipe end or hose end 3 has a circumferential wall 12 which is coaxial with its longitudinal center axis 11 and has substantially the same wall thickness along the entire length and the entire circumference of the pipe end or hose end 3, wherein this wall thickness is smaller than the wall thickness of the circumferential wall 6 of the pipe socket 2. Surrounding an opening of the pipe end or hose end 3, which in FIG. 1 faces the pipe socket 2, the circumferential wall 12 of the pipe end or hose end 3 has a conical expansion 13 or flare which diverges towards the pipe socket 2, facilitating attachment of the pipe end or hose end 3 on the pipe socket 2. After the expansion 13 or flare, the pipe end or hose end 3 has a generally cylindrical circumferential wall section 14, with the outer circumferential surface of the wall section 14 forming a seat 15 for the pipe or hose clamp 4. The outer circumferential surface or the clamp seat 15, respectively, has a width B that corresponds to the width of the pipe or hose clamp 4. The front end of the circumferential wall section 14 abuts the expansion 13 or flare; at this location as well as along a conical ring shoulder 18 of the pipe end or hose end 3 that borders the rear end of the circumferential wall section 14, the circumferential wall 12 protrudes radially outwardly over the clamp seat 15, thereby securing the pipe or hose clamp 4 on the clamp seat 15 during and after tightening of the pipe or hose clamp 4 and preventing its axial movement.

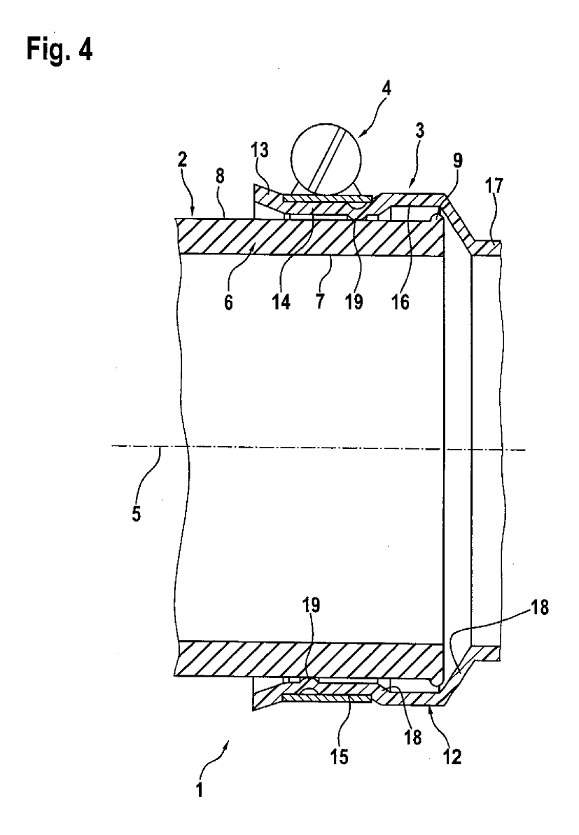

Behind the ring shoulder 18, the pipe end or hose end 3 has first an expansion of the cross-section 16 and then a narrowing of the cross-section 17, which are separated from the expansion of the cross-section 16 by an additional conical ring shoulder 18. The expanded pipe end or hose end 3 narrows at the additional ring shoulder 18 to a cross-section having an inner diameter that corresponds to the inner diameter of the pipe socket 2, so as to minimize the flow resistance of the pipe connection or hose connection 1. The expansion of the cross-section 16 operates to receive the ring collar 9 on the free end of the pipe socket 2, as illustrated in FIG. 4, which after passing the circumferential wall section 14 snaps in the expansion of the cross-section 16.

A ring collar 19, which protrudes inwardly over a cylindrical inner circumferential surface 20 of the circumferential wall section 14 and extends uninterruptedly in form of a ring around the entire circumference of the pipe end or hose end 3, is formed in the circumferential wall section 14 in the region of the clamp seat 15. The width of the ring collar 19 is approximately one fourth of the width of the clamp seat 15. After the pipe or hose clamp 4 is tightened, the ring collar 19 is pressed behind the ring collar 9 of the pipe socket 2 against its cylindrical outer circumferential surface 8, wherein the surface pressure is increased due to the small a width of the ring collar 19 compared to the width of the clamp seat 15, thereby improving the sealing action.

The inner diameter of the ring collar 19 corresponds approximately to the outer diameter of the cylindrical outer circumferential surface 8 of the pipe socket 2, allowing the pipe socket 2 to slide immediately after placement of the pipe end or hose end 3 on the pipe socket 2 along this circumferential surface 8. However, this implies that the ring collar 19 beforehand strikes the ring collar 9 on the free end of the pipe socket 2, because the ring collar 9 protrudes outwardly over the circumferential surface 8.

Whereas in this case a pipe or hose end of an intake air pipe or an intake air hose made from an elastomer material can be elastically expanded to allow it to move across the ring collar 9, this is not possible with the pipe end or hose end 3 of the intake air pipe or the intake air hose made from plastic by blow molding, because although the pipe end or hose end 3 can be slightly deformed due to its relatively small wall thickness, it cannot be expanded at all or only by applying considerable force.

In order to be nevertheless able to move one ring collar 19 on the inside of the pipe or hose end 3 across the other ring collar 9 on the outside of the pipe socket 2, the first mentioned ring collar 19 of the pipe end or hose end 3 illustrated in FIGS. 1 to 4, unlike conventional pipe and hose ends 3, does not extend along a center plane E2 of the clamp seat 15 perpendicular to the longitudinal center axis 11 of the pipe end or hose end 3, but extends instead along a plane E3 that is inclined with respect to the plane E2 by an angle α. The angle of inclination α between the two planes E2 and E3 is about 10° with the pipe end or hose end illustrated in FIGS. 1 to 4. The angle of inclination α is defined by the radius R and the width B of the clamp seat 15, wherein advantageously tan α=B/2R; tan α is actually slightly smaller than B/2R due to the width of the ring collar 19. Advantageously, the ring collar 19 extends in the circumferential direction of the circumferential wall section 14 over its entire width and/or over the entire width B of the clamp seat 15; the ring collar 19 extends in FIG. 1 on the top side of the pipe end or hose end 3 to the rear end of the circumferential wall section 14 and on the diametrically opposed bottom side of the pipe end or hose end 3 to the front end of the circumferential wall section 14.

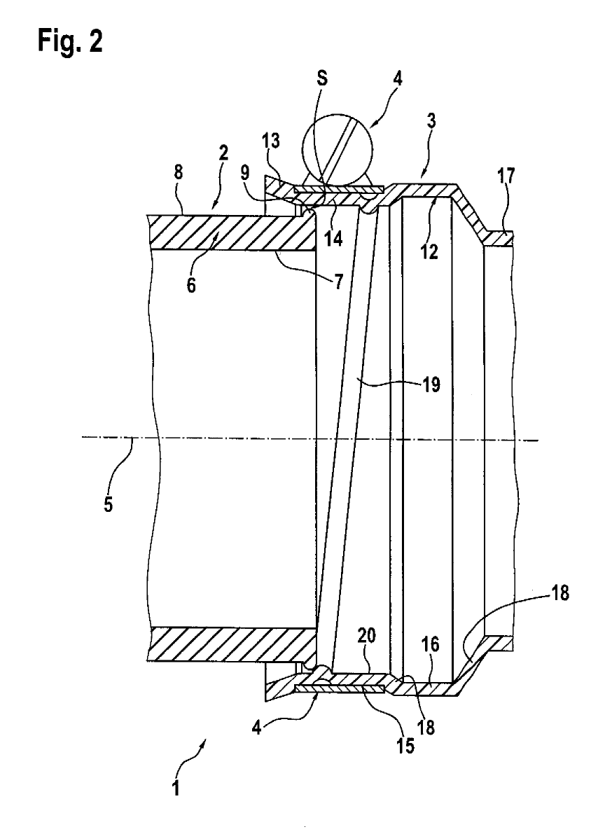

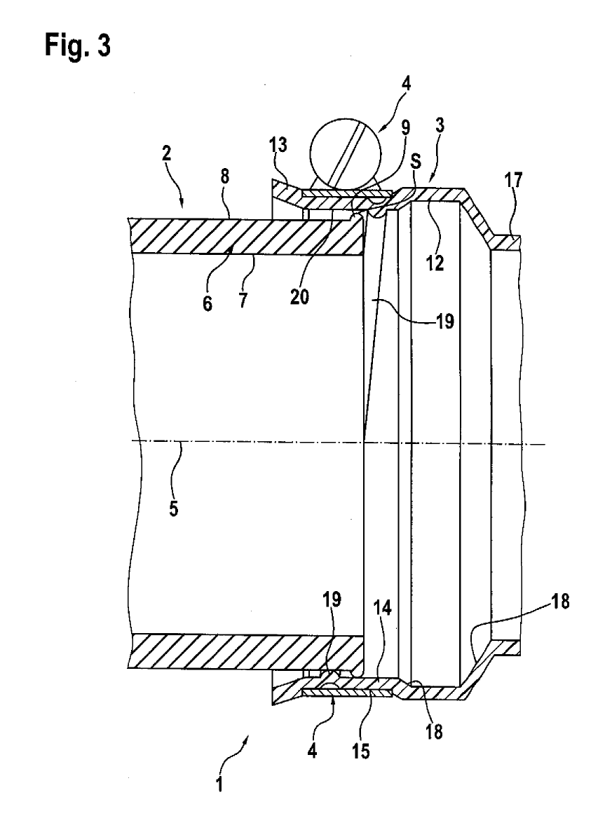

Due to the inclination of the ring collar 19, the two ring collars 9, 19 do not abut each other along the entire length simultaneously when the pipe end or hose end 3 is attached on the pipe socket 2. Instead, the ring collar 19 contacts the ring collar 9 only at a single location, as illustrated in FIG. 2 on the bottom side of the pipe or hose end 3 and the pipe socket 2, whereas a small gap S remains between the cylindrical inner circumferential surface 20 of the circumferential wall section 14 and the ring collar 9 of the pipe socket 2 along the remaining circumference of the pipe end or hose end 3, as illustrated in FIG. 2 on the top side of the pipe or hose end 3 and the pipe socket 2. With this gap S, the pipe end or hose end 3 can now be slightly deformed from its circular shape when pressed in the mounting direction against the pipe socket 2. The radius R of the circumferential wall section 14 becomes slightly larger in the region of the contact point between the two ring collars 9, 19 due to the deformation or runout, so that one ring collar 19 can slide on the other ring collar 9. After overcoming this threshold, the two ring collars 19, 9 slight past each other, wherein they are always in contact with each other at only two contact points, as illustrated in FIG. 3. The dynamic friction can then be kept relatively small, eliminating excessive resistance against movement during placement of the pipe end or hose end 3 on the pipe socket 2. After passing the ring collar 19 or the circumferential wall section 14, the ring collar 9 of the pipe socket 2 locks in the expansion of the cross-section 16 of the pipe end or hose end 3, as illustrated in FIG. 4.

The pipe or hose clamp 4 can then be tightened to secure the pipe end or hose end 3 on the pipe socket 2, wherein the ring collar 19 is pressed with a high surface pressure against the cylindrical outer circumferential surface 8 of the pipe socket 2.

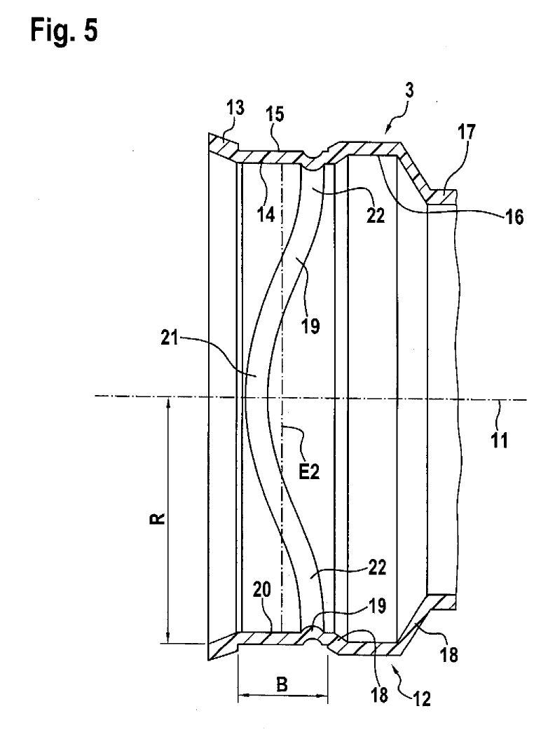

Unlike the pipe end or hose end in FIGS. 1 to 4, the circumferential ring collar 19 on the pipe end or hose end 3 illustrated in FIG. 5 has a sinusoidal shape in the circumferential direction of the pipe end or hose end 3, with two wave crests 21 (only one is visible) oriented in the direction of the pipe socket 2 and two wave troughs 22 located between the wave crests 21, so that the ring collar 19 intersects the center plane E2 of the clamp seat 15 at four locations. The peaks of the wave crests 21 and the peaks of the wave troughs are each arranged in axial direction in close proximity of the two axially opposed boundary edges of the clamp seat 15 and are each located on a plane that is perpendicular to the longitudinal center axis 11 of the pipe end or hose end 3, so that the peaks of the two wave crests 21 facing the pipe fitting 2, which are diametrically opposed in relation to the longitudinal center axis 11, come simultaneously into contact with the ring collar 9 when the pipe end or hose end 3 is attached on the pipe socket 2. After the two ring collars 9, 19 have moved on top and past each other, they are each in contact at four contact points.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A pipe connection or hose connection, comprising:
a pipe socket having at least one outwardly protruding circumferential second ring collar,
a pipe end or hose end comprising a radially inwardly protruding, circumferential first ring collar, said pipe end or hose end attached on an outside of the pipe socket, and
a clamp holding the pipe end or hose end on the pipe socket, wherein the first ring collar has a width that is smaller than a width of the clamp and the first ring collar moves over the second ring collar when the pipe end or hose end is attached on the pipe socket,
wherein the second circumferential ring collar extends along a first plane that is perpendicular to a longitudinal center axis of the pipe socket, while the first circumferential ring collar intersects at least at two locations with a second plane that is perpendicular to the longitudinal center axis of the pipe end or hose end, so that the two ring collars are not simultaneously in contact along their entire length when the first ring collar moves across the second ring collar when the pipe end or hose end is attached on the pipe socket.

2. The pipe connection or hose connection of claim 1, wherein the first circumferential ring collar extends along a third plane that is inclined with respect to the longitudinal center axis of the pipe end or hose end.

3. The pipe connection or hose connection of claim 1, wherein the first circumferential ring collar has a wavy shape and intersects the second plane at least at four locations.

4. The pipe connection or hose connection of claim 1, wherein the first circumferential ring collar intersects the second plane at least at two locations.

5. The pipe connection or hose connection of claim 4, wherein the second plane is a longitudinal center plane of the clamp or of a clamp seat.

6. The pipe connection or hose connection of claim 1, wherein the pipe end or hose end is part of an intake hose or charge-air hose of an intake passage of a combustion engine, and wherein the pipe socket is part of another component of the intake passage of the combustion engine.

7. An air pipe or air hose for an intake passage of a combustion engine, comprising:
a pipe end or hose end for attachment on a pipe socket, and
a clamp seat for a clamp operating to attach the pipe end or hose end on the pipe socket,
wherein the pipe end or hose end has a circumferential ring collar which protrudes radially inwardly from the clamp seat and has a width that is smaller than a width of the clamp seat,
wherein the ring collar intersects at least at two locations with a longitudinal center plane of the clamp seat that is perpendicular to the longitudinal center axis of the pipe end or hose end.

8. The air pipe or air hose of claim 7, wherein the pipe end or hose end has before the clamp seat an expansion of a cross-section which diverges towards a free end of the pipe end or hose end.

9. The air pipe or air hose of claim 7, wherein the pipe end or hose end has after the clamp seat a narrowing of a cross-section.

10. The air pipe or air hose of claim 7, wherein the pipe end or hose end has after the clamp seat an expansion of a cross-section.

11. The air pipe or air hose of claim 10, wherein the expansion of the cross-section is followed by narrowing of the cross-section.

12. The air pipe or air hose of claim 7, wherein the air pipe or air hose is a blow-molded plastic part with a substantially constant wall thickness.

13. The air pipe or air hose of claim 7, comprising an expanded cross-section on two sides of the clamp seat.

14. A component for an intake passage of a combustion engine, comprising a pipe socket for attachment of a pipe end or hose end of an air pipe or an air hose, the pipe socket having at least one outwardly protruding circumferential ring collar intersecting at least at two locations a plane that is perpendicular to a longitudinal center axis of the pipe socket.
